(19) United States
(12) Patent Application Publication
(10) Pub. No.: US 2013/0131985 A1
(43) Pub. Date: May 23, 2013

(54) WEARABLE ELECTRONIC IMAGE ACQUISITION AND ENHANCEMENT SYSTEM AND METHOD FOR IMAGE ACQUISITION AND VISUAL ENHANCEMENT

(71) Applicants: James D. Weiland, VALENCIA, CA (US); Mark S. Humayan, Glendale, CA (US); Gerard Medioni, Los Angeles, CA (US); Armand R. Tanguay, JR., Yorb Linda, CA (US); Vivek Pradeep, Snohomish, WA (US); Laurent Itti, Los angeles, CA (US)

(72) Inventors: James D. Weiland, VALENCIA, CA (US); Mark S. Humayan, Glendale, CA (US); Gerard Medioni, Los Angeles, CA (US); Armand R. Tanguay, JR., Yorb Linda, CA (US); Vivek Pradeep, Snohomish, WA (US); Laurent Itti, Los angeles, CA (US)

(21) Appl. No.: 13/444,839

(22) Filed: Apr. 11, 2012

Related U.S. Application Data
(60) Provisional application No. 61/474,197, filed on Apr. 11, 2011.

(51) Int. Cl. G01C 21/20; G08B 3/00; G08B 6/00

(52) U.S. Cl. CPC G01C 21/20; G08B 6/00; G08B 3/00
USPC 701/516; 340/4.12

(57) ABSTRACT

The system comprises a wearable, electronic image acquisition and processing system (or visual enhancement system) to guide visually impaired individuals through their environment, providing information to the user about nearby objects of interest, potentially dangerous obstacles, their location, and potential paths to their destination.

This application claims priority to U.S. Provisional Patent Application 61/474,197 filed on Apr. 11, 2011 which is incorporated by reference herein in its entirety.

### STATEMENT OF FEDERALLY SPONSORED RESEARCH

This invention was made with government support under Grant No. EEC-0310723 awarded by the National Science Foundation. The government has certain rights in the invention

### BACKGROUND OF THE INVENTION

1. Field of the Invention

The present invention is directed to wearable image acquisition systems and methods and more specifically to visual enhancement systems and methods.

2. Background

Traumatic brain injury (TBI) is widely acknowledged as a major medical issue facing soldiers injured in recent conflicts. Epidemiological studies indicate that 80% of the 3,900 troops reported by the Defense Veterans Brain Injury Center (DVBIC) with TBI have reported visual problems, while other reports suggest that as many as 39% of patients with TBI also have permanently impaired vision. Ocular trauma occurring with TBI exacerbates visual deficits. Even though the incidence of TBI-related visual dysfunction is low in the military population, vision loss can interfere with non-visual rehabilitation efforts and erode long-term quality of life. Improvements in the diagnosis and treatment of TBI-related visual dysfunction can dramatically improve the lives of military personnel. In addition, the general public benefits tremendously from advances in low-vision treatment, particularly the millions of people with vision loss related to age-related macular degeneration (AMD), diabetes, glaucoma, or acquired brain injury.

Visual Dysfunction Related to TBI and Ocular Trauma Vision is the primary sense by which humans interact with the world. Seventy percent of sensory neurons are visual, and 30 to 40% of the brain is dedicated to processing visual information. Thus, it is easy to understand why TBI often causes visual dysfunction. Even in the absence of a penetrating injury, concussive effects from explosions can permanently damage the brain and impair vision. Recent studies conducted at the Veterans Affairs Palo Alto Health Care System have identified multiple visual disorders that can result from TBI and/or ocular trauma, ranging from total blindness to an inability to visually track objects. In one study, 50 subjects were evaluated, all of whom were diagnosed with TBI. One of the more striking results was that 38% of the subjects “sustained vision loss that ranged from moderate to total blindness”.

One reason for the high rate of visual dysfunction following TBI is that blast injuries that result in TBI can also damage ocular structures. Combat ocular injuries occur concurrently with TBI in 66% of cases. Combat eye injuries related to traumatic brain injury (TBI) have slowly increased in the past few decades due to two main factors. One factor is improved body armor that shields vital organs but does not protect the eyes. Therefore, soldiers today survive explosions that years ago would have produced fatal injury, yet these explosions may damage the brain and eyes. Also, military tactics have changed. The increased use of explosive fragmentation from artillery and aircraft has contributed to the rise in ocular trauma. The incidence of ocular injuries has increased from 0.65% of all injuries in the Crimean War (1854), to about 5% to 10% in the Vietnam War, to about 13% in Operation Desert Storm. In Operation Enduring Freedom/Operation Iraqi Freedom (OEF/OIF), open-globe and adnexal laceration ocular injuries are most often caused by fragmentary explosive munitions (73% to 82%), and often resulted in permanently impaired vision.

Despite the increase in incidence in the last few decades, the number of individuals with visual field loss or blindness related to TBI remains relatively small as a proportion of the military population, though this number may be underreported. A study of 108 patients found that those who have injuries from blast events are about twice as likely to have a severe visual impairment as compared with those whose injuries are caused by other events. Overall, 26% of this population is either blind, has a best-corrected visual acuity of 20/100 or less, or has a very severe visual field loss. In less severe TBI cases, significant abnormalities in visual function were found despite normal or near-normal visual acuity by conventional testing. In patients with mild TBI, self-reported data and visual screenings of 124 OEF/OIF Palo Alto Health Care System patients with near-normal optometric results suggest that as many as 40% of these patients have one or more binocular vision dysfunction symptoms. Therefore, the incidence of visual field loss could be underreported, even in patients who have undergone visual acuity testing.

Dual sensory impairment (DSI) to both visual and auditory systems has also been reported in VA polytrauma patients. In a population of 63 polytrauma patients injured by a blast event receiving both comprehensive audiological and vision examination, 32% were found to have DSI, 19% hearing impairment only, 34% vision impairment only, and 15% no sensory loss. The presence of DSI was associated with reduced function as measured by the Functional Independence Measure, both at admission and discharge. The consequences of eye injuries and/or the presence of dual sensory loss can go beyond the initial diagnosis and treatment, and have far-reaching effects on the quality of life. Patients with traumatic eye injuries are at risk for developing sight-threatening complications later in life and often require life-long eye care. In addition, visual impairments and dysfunctions can complicate other non-visual rehabilitation efforts and impair the patient's ability to pursue education, obtain employment, and function socially.

Vision issues are not limited to war-related injuries or to military personnel but extend to the general population as a whole, where vision may be impaired for any of a variety of reasons.

Low-Vision Impacts Mobility

Research on low vision travelers has shown, not surprisingly, that visual characteristics are important determinants of travel ability in various settings. Contrast sensitivity, visual acuity, and visual field deficits have all been shown to reduce mobility effectiveness and safety. Impaired mobility is also a known risk factor for falls and is correlated with mortality.

Low vision travelers may rely upon their existing vision or utilize a variety of tactile (cane) or optical devices. Telescopes, for example, are used as orienting devices (e.g., reading street signs and locating landmarks) and as clear path detectors; however, low vision travelers generally use these devices infrequently and in unfamiliar environments and these rarely play a role in detecting hazards in the immediate travel path. Filters (sun glasses) are more commonly used to reduce light levels and/or glare, which serves the purpose of maximizing the user's visual capacity. Low vision travelers may also use GPS systems as navigational tools. Mobility training that may include training in the use of low vision devices is one of the primary tools used in vision rehabilitation to optimize travel efficiency and safety.

While orientation and mobility training as currently used dates to about 1948, only recently have attempts been made to objectively assess the effectiveness of training. Clark-Carter and colleagues developed the Percent Preferred Walking Speed (PPWS) concept, which compares an ideal walking speed (pace set by an individual with a sighted guide who ensures safety) with alternative travel modalities. For example, the preferred walking speed using a guide dog is about 104% of the preferred walking speed, while cane travel is some 95% to 97% of the preferred walking speed. This measure has found use in a variety of studies examining travel with different devices and under different conditions (e.g., day vs. night). More recently Ludt and colleagues developed the Distance Vision Recognition Assessment (DVRA), which determines the distance at which the traveler can visually detect drop-offs, surface obstacles, and head-height obstacles Combining PPWS and DVRA would assess the individual's travel speed and ability to identify and avoid potential hazards. Thus, there is a sound basis upon which to evaluate the effectiveness of the proposed visual enhancement system.

In the prior art; a number of electronic systems to aid mobility and object recognition in blind individuals have been proposed.

Electronic Systems to Aid Blind Individuals

Electronic Travel Aids (ETA) are used by the visually impaired to enhance user confidence for independent travel, rather than to replace conventional aids like the cane and guide dog. Most ETAs are based on ultrasound, laser ranging, or imaging, and currently no standardized or complete system is available on the market. All such devices employ three basic components: an element that captures data on environment variables, a system to process this data and, finally, an interface that renders this information in a useful way to the person. Since the users are typically blind, the user interface employs another sensory channel, either hearing or touch, to convey information. Such an approach is called sensory substitution.

Reflectance based devices emit a signal, either light or sound, and analyze the reflected signal to localize objects. Notable examples include the Mowat Sensor, the Nottingham Obstacle Detector (NOD), and the Binaural Sonic Aid (Sonicguide). These devices require significant training, as the lack of contextual information in range data limits algorithmic interpretation of the environment. Furthermore, the user often has to perform additional measurements when an obstacle is detected, to determine object dimensions; the precision of these perceived dimensions is variable, in turn based upon the width of the signal emitted by the device and the cognitive/perceptual capacities of the user. All of this requires conscious effort that also reduces walking speed. For example, the C-5 Laser Cane (a.k.a. Nurion Laser Cane) introduced in 1973 by Benjamin, et al. can detect obstacles up to 3.5 m ahead of the user. The infrared-based Pilot Light mini-radar and Guideline have approximately 1 m range. All reflectance-based systems are active (emit a signal); hence, power consumption, portability, traversability, and lack of complete user control limit system effectiveness. Although laser systems have better spatial resolution than ultrasound, they have difficulty resolving reflections off of specular surfaces (e.g., windows) and fail outdoors where sunlight often overwhelms the reflected signals.

GPS-based devices, such as the Loadstone GPS project running on Nokia phones have also been proposed for navigation assistance for the blind. For locations where no map data is available, the Loadstone software allows creation, storage and sharing of waypoints. The Victor Trekker (Humanware) is another GPS-powered PDA application that can determine position, create routes and assist navigation. Other devices include Wayflnder Access, BrailleNote GPS, Mobile Geo and MoBIC (Mobility of Blind and Elderly people Interacting with Computers). GPS-based systems provide points-of-interest (POI) information but cannot resolve details at the local level. They do not aid obstacle avoidance and indoor navigation. The NAVIG project aims to integrate GPS with computer vision algorithms for extracting local scene information. The computer vision techniques we propose can be integrated with GPS systems and would enable completely independent navigation in truly large-scale and unfamiliar environments.

Distributed systems employ navigational aids embedded as part of the environment to facilitate access for the visually impaired. Talking Signs is an actively deployed example, which uses short audio signals sent by infrared light beams from permanently installed transmitters to a hand-held receiver that decodes the signals and delivers or utters the voice message. A similar indoor system uses a helper robot guide, and a network of RFID tags for mapping, and sonar for local obstacle avoidance. While these systems perform admirably, they are by design too constrained for general purpose navigation, and are likely not cost and time effective for installation in homes, smaller locations, or environments familiar to the traveler. As with GPS, the system we propose will either work with infrastructure such as Talking Signs, where available, but will also work autonomously.

Imaging-based mobility aids have more recently emerged thanks to wider availability of inexpensive cameras and faster processors. The vOICe, for instance, converts images into sounds, and plays back the raw sound waves, to be interpreted by the user. Other systems include those using two or more cameras to compute dense scene depth, conveyed to the user via a tactile interface. The user then learns to associate patterns of sound or tactile stimuli with objects. These approaches leave the heavy inference work to the human, flood them with massive amounts of raw data, and hence impose significant training time and severe and distracting cognitive load. ASMONC is another vision system integrated with sonar. An initial calibration step by standing in an obstacle-free, texture rich zone is required. As the user moves, the ground plane is tracked and surface inconsistencies (obstacles or drop-offs) are detected. As the sensors are fixed on the waist and shoulders, the subject has to perform bodily rotations to integrate scene information. At the Quality of Life Technology Engineering Research Center (QoLT ERC) at CMU, a vision-based wearable assistive device is being developed that performs several specific indoor tasks such as scene geometry estimation and object detection. Several systems exist for other tasks that certain visually impaired subjects might be able to perform, like driving. An interesting sensory substitution system pioneered by Bach-y-rita uses electrical stimulation of touch receptors in the tongue to convey visual information. Now implemented as “Brainport”, this device has a head-worn camera and wearable processor that convert camera information into a pattern of stimulation applied to the tongue via an array of microelectrodes.

The current state-of-the-art in visual aids for the blind is fragmented and inadequate, such that these technologies are not widely adopted. While each of the aforementioned systems has some desirable properties, all have potentially fatal flaws limiting acceptance. The primary flaw is the constant overwhelming flow of raw tactile or aural information to the user. For route planning and medium planning distance (1 to 50 m) obstacle detection, it seems necessary to only provide information on an as-needed basis. Users are unlikely to give up a cane or guide dog, as these provide a needed safety margin, since no single aid can be considered 100% reliable and the cost of a missed obstacle is potentially high. GPS-based systems may provide occasional information, but cannot possibly inform the subject on nearby obstacles, not part of the GPS database. Systems like talking signs are not autonomous, since they require infrastructure. An additional common flaw in systems investigated to date is their task-specific nature, in that they are based on task-specific algorithms that often must be user-selected.

### SUMMARY OF THE INVENTION

The present system provides a wearable system to assist patients with impaired visual function, for instance, due to secondary to brain or eye injury. However, the system has equal application to any visually impaired user, regardless of the source of impairment The system addresses one of the shortcomings of prior art systems by greatly increasing the level of processing—condensing millions of raw image pixels to a few important situated object tokens—thereby reducing device-to-user communication bandwidth. The system is intended to analyze the visual environment of the user and to communicate orienting cues to the patient without the overwhelming sensory feedback that limits current systems. The system is intended to help localize and identify potential objects of interest or threats that the user may not be able to see or to attend to perceptually. As such, the majority of the sensory and cognitive load is transitioned to an assistive device, reducing the sensory and cognitive loads on the patient. The proposed system is based on a platform that allows broad task applicability, and features robust hardware and software for operation both indoors and outdoors under a broad range of lighting conditions. The system is a non-reactive strategy for providing a path to an object or destination and provides navigational cues to aid the user in following the path.

In one embodiment, the present invention includes a wearable system with advanced image sensors and computer vision algorithms that provide desired and relevant information to individuals with visual dysfunction.

The system uses a simultaneous localization and mapping (SLAM) algorithm for use in obstacle detection for visually impaired individuals during ambulation. The system contemplates neurally-inspired attention algorithms that detect important objects in an environment for use by visually impaired individuals during search tasks. In one embodiment, the system utilizes a miniaturized wide field-of-view, wide-dynamic range camera for image capture in indoor and outdoor environments The system uses a controller for overall system control and integration, including functionality for a user interface and adaptation to different tasks and environments, and integrate the camera and all algorithms into a wearable system.

The system comprises a wearable, electronic image acquisition and processing system (or visual enhancement system) to guide visually impaired individuals through their environment, providing information to the user about nearby objects of interest, potentially dangerous obstacles, their location, and potential paths to their destination. The system may be targeted towards individuals with total blindness or significant visual impairment. The wearable system is applicable to more prevalent vision problems, including partial blindness and neurological vision loss. The system is applicable to any type of blindness, whether the cause of visual impairment relates to brain injury, eye injury, or eye disease, or other causes

### BRIEF DESCRIPTION OF THE FIGURES

FIG. 1 is a block diagram of an embodiment of the system.

FIG. 2 is a flow diagram illustrating operation of an embodiment of the system in mobility mode.

FIG. 3 is a flow diagram illustrating operation of the system in indoor mode.

FIG. 4 is a flow diagram of an embodiment of the system in providing routing information.

FIG. 5 is an example of a lens system in an embodiment of the system.

FIG. 6 is an example of an intraocular camera (IOC) in an embodiment of the system.

FIG. 7 is an example computer implementation in an embodiment of the system.

### DETAILED DESCRIPTION OF THE INVENTION

One embodiment of the present invention is a wearable, electronic image acquisition and processing system (or visual enhancement system) to guide visually impaired individuals through their environment, providing information to the user about nearby objects of interest, potentially dangerous obstacles, their location, and potential paths to their destination.

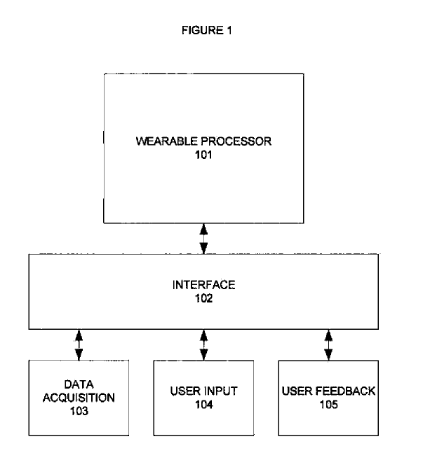

The system in one embodiment is implemented as illustrated in FIG. 1. The system comprises a wearable processor that can receive data from a data acquisition system 103 via interface 102. The system includes a user input device 104 that allows the wearer to request information or assistance from the system as needed. A user feedback unit 105 provides information to the user about the user's environment in response to the user's request, input, and/or pursuant to an automatic operation mode.

In one embodiment, the data acquisition module 103 comprises glasses that include a camera, preferably a highly miniaturized, low power camera discretely mounted within the frame. The camera will feature a wide field-of-view to provide both central and peripheral vision, as well as wide dynamic range to allow operation both outdoors and indoors, and to equalize the image detail in bright and dark areas, thus providing consistent images to the software algorithms. The camera can include a local rechargeable power supply that is onboard or is coupled via a connection to a separate battery pack. The camera will transmit information via the interface 102 which may be a wireless interface between the components. In one embodiment, they system can be integrated into a wearable system with wired connections between the components as desired.

The camera/glasses transmit images or a video stream to the wearable processor which may be implemented as a smart-phone, purpose-built processing system, or as a some other portable and wearable processing system, such as a Personal Data Assistant, or PDA. The processor operating mode can be determined both by user control using the user input 104 (for example, via tactilely coded key pad or voice command system via a microphone). In one embodiment, the system may provide automatic environment detection (outside vs. inside, mobile vs. stationary—based on outputs from the scene gist and SLAM algorithms), with the user being able to override any automatic decisions. The processor 101 will detect important objects (based on saliency and top-down priors from gist) and then communicate via the user feedback device 105 to provide tactile and/or aural information to assist the user in completing the desired task. The user feedback device 105 may be an earpiece through which the wearer can receive information, and/or it can comprise a tactile feedback unit that will create some sensation to the user (e.g. vibration, vibration pattern, raised areas, and the like) that will communicate information about the environment.

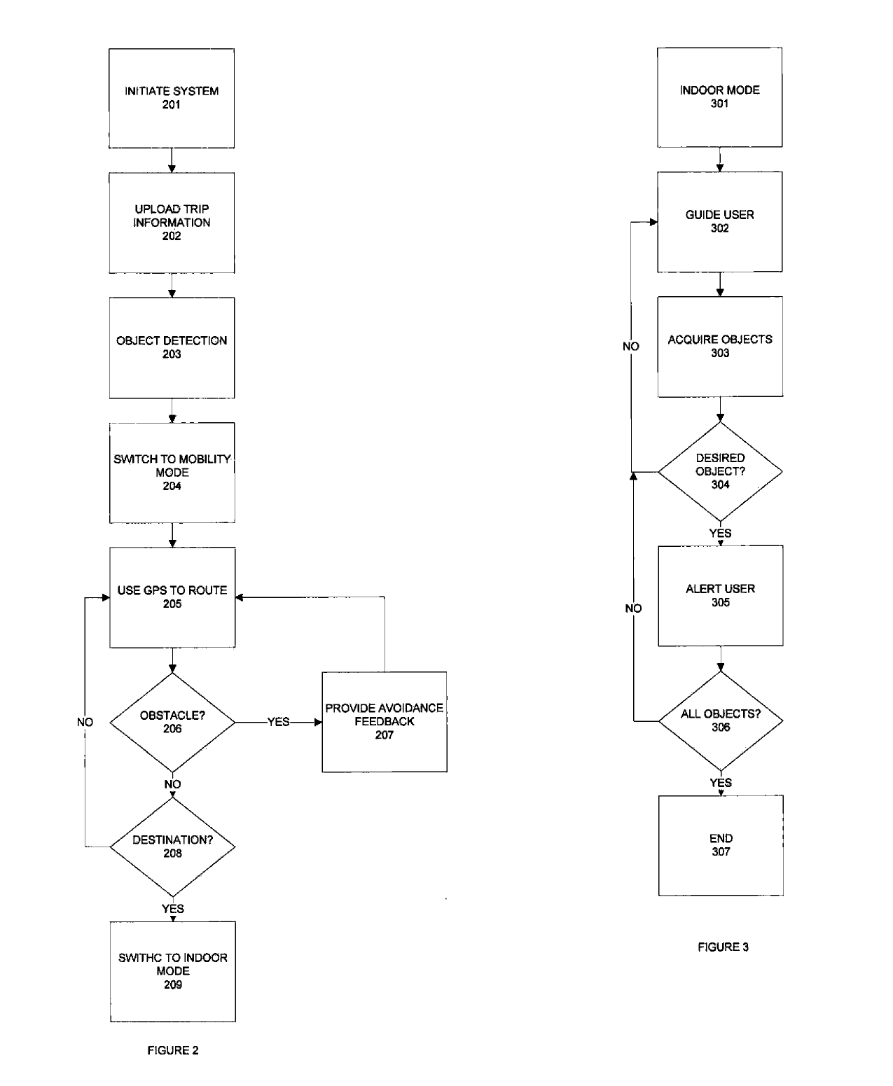

An example user scenario might involve the user going from their house to a store and back. FIG. 2 is a flow diagram illustrating the operation of the system during this example trip. At step 201 the user initiates the system. In one embodiment, the system has several modes of operation, including, for example, indoor mode, mobility mode, and object detection mode. The user is able to switch between modes as needed, using voice commands, keyboard commands, switches, and the like. In this embodiment, the system defaults to indoor mode upon initiation. Before departing, the user uploads information at step 201 to the processor 101 to help plan the trip, such as the name and address of the store. This can be accomplished using a home computer adapted for his or her use and able to interface in some manner with the wearable processor 101. With the information loaded, the user prepares to leave home and preferably uses an object detection algorithm (in indoor mode) to find items for the trip. For example, the user may search for the user's keys (for instance, in one embodiment, with a voice command “Find keys”). The processor then preferably switches to an object detection mode at step 202, finds one or more interesting objects in front of the user, and biases the algorithm based on stored images of keys. A wide dynamic range camera preferably enhances image contrast even in the dimly lit home. Preferably, a user feedback device then guides the user to his keys at step 203.

After leaving home, the processor switches to mobility mode (either automatically based on movement or by command of the user, in alternate embodiments) at step 204. Preferably, the system guides the user towards the desired destination. At step 205, while in mobility mode, the system uses GPS information to select a route and to determine if rerouting might be required based on user behavior or other factors. Preferably, preloaded, GPS destination information (street address of store) works together with the mobility algorithm to provide information on intersections. While GPS can identify the intersection, a local mobility algorithm preferably guides the user safely across the street.

At decision block 206, the system determines if there is an obstacle in the path. If so, the system alerts the user at step 207 and provides avoidance information. The system then returns to step 205 to continue routing. The system in one embodiment has wide dynamic range for the data acquisition system. For example, even on a sunny day, the wide-dynamic range camera can detect an obstacle in the shade or in the sun and alerts the user to its presence. The system may also have a dta acquisition system with a wide field of view, so that obstacles to the left and the right, as well as above and below, the user can be detected and avoided.

If there is no obstacle at decision block 206, the system proceeds to decision block 208 to determine if the destination has been reached. If not, the system returns to step 205 and continues routing the user to the destination. If the destination has been reached, the system switches to indoor mode at step 209.

The indoor mode operation of the system is illustrated in the flow diagram of FIG. 3. At step 301, once inside the store, the processor preferably switches to indoor mode (which is preferably done automatically). At step 302 the system guides the user around the store, preferably helping to identify objects on the shelf. This may be done by a stored map of the store or by leading the user up and down aisles in some order. If the user has been to the store before, the system may have been “trained” for the store layout.

At step 303 the system acquires objects as the user moves through the store. This is via the optical input means of the system, which may include a camera system with a narrow field of view in addition to the camera system with a wide field of view described above. At decision block 304 it is determined if an acquired object is a desired object for the user. This identification could be aided by a database of objects preloaded or available wirelessly to the system. This step can involve the system “reading” the identification of each object to the user and the user indicating a desire to obtain that object. In another embodiment, the user could have preloaded a “shopping list” of items into the system so that the system will specifically look for objects from the list. Alternatively, the user may use the user input to query the system to find an object.

In one embodiment, the system can acquire object information via any of a number of ways, for example, by comparing an image capture of an object to a stored image of the object, by reading a bar code associated with the object or with a shelf location of the object, by reading a QR code or other two dimensional bar code associated with the object, by reading an RFID chip associated with the object and comparing the result to a database of object information, or by any other self identifying system employed by the manufacturer or distributor or seller of an object.

If the object is a desired object at decision block 304, the system alerts the user at step 305 so the user can pick up the object. If the object is not a desired object, the system returns to step 302. After the user has been alerted at step 305, the system proceeds to step 306 to determine if all objects have been acquired. If not, the system returns to step 302 and continues to guide the user. If all objects have been acquired at decision block 308, the system ends at step 309.

Once the user has completed shopping, in a preferred embodiment, the system will guide him to the checkout and then to the store exit. Since the processor has preferably mapped the route on the way, the saved map can be used to guide the user on the return trip. This map can also be saved for future use.

The example above describes a complex optical and electronic system that uses locally running algorithms on the processor coupled to a larger database of GPS coordinates and object attributes that may be available wirelessly. The system provides algorithms needed for a wearable system and systems integration, but leave provisions in the system for integration with the larger wireless network and demonstrate wireless integration in a limited sense.

Use of a Simultaneous Localization and Mapping (SLAM) Algorithm for Use in Obstacle Detection for Visually Impaired Individuals During Ambulation

The system implements Simultaneous Localization and Mapping (“SLAM”) techniques. The structure for a SLAM algorithm may be preferably incorproated as a real-time (10 frames/sec) PC implementation running on a Pentium IV, 3.36 GHz processor with 3 GB RAM. In one embodiment of the system, the algorithm is modified for handling the various failure modes that can be expected in real-world deployment, improving global consistency of the computed maps, performing scene interpretation, and providing systems level integration into a portable system.

Improved Robustness of the SLAM Algorithm Extraction of high-level features for tracking: Current SLAM systems track point features across frames for estimating camera trajectory and building maps. However, tracking points becomes difficult on non-textured areas such as walls or large spaces. In areas of uniform intensity, point features are also badly localized. This can lead to tracking failure and is often encountered in indoor environments. This situation can be remedied by using higher level features such as lines, planes, and quadrics (instead of points)that might be more robust to illumination conditions and easily extracted from wall junctions and facades of even low-textured regions. The system can monitor the walking speeds of the user and determine the update requirement for the system. In some cases, it is not necessary to perform the map update every frame. Instead, the time may be used to perform global, nonlinear optimization for improving the overall structure of the map. To accomplish this efficiently, the whole algorithm may be implemented as a multithreaded process, with parallel threads for mapping, motion estimation, and obstacle detection.

Multi-object/people tracking: Camera motion estimation is based on the assumption that the scene is static. Moving objects, as long as they do not occupy a significant field of view, can be filtered away in one embodiment by applying various geometric and statistical techniques. However, the user might need to be alerted if other people or moving objects are projected to intersect or collide with the user motion vector. To this end, a multi-object tracking algorithm preferably is integrated into the system, possibly leveraging the biologically-inspired algorithms described below. Experimental studies can determine the range at which such tracking is required. This determines the level of occlusion and complexity of object shape that the object tracking algorithm should handle.

Implementation of the SLAM Algorithm onto a Wearable System.

A wearable stereo camera system: The input data for the SLAM system are provided by a pair of calibrated cameras that perform triangulation to estimate scene depth. The cameras should be fixed rigidly with respect to each other, as any accidental displacement can have a negative impact on the quality of 3D reconstruction. At the same time, the head-mounted system must be light weight and unobtrusive, for example by mounting small cameras on a pair of eyeglasses. In one embodiment, one may employ small CCD cameras and house them in a plastic casing that can be clipped on to the rim of a pair of spectacles. Wide field-of-view, wide dynamic range cameras are preferably utilized. 3D range data and captured images are preferably transmitted wirelessly to a waist-mounted processing board for running the SLAM algorithm. In other embodiments, the system may employ a pair of glasses that have the cameras built in, ensuring position consistency between the cameras. In one embodiment, the system may periodically request the user to perform registration of the cameras via a test algorithm.

System specifications for the SLAM processor: User input can be used to design various embodiments of the SLAM system. For example, in one embodiment, the system sends cues to warn about the presence and location of obstacles, or compute an optimal path towards a desired goal. The instructions for the latter could be obtained verbally or from a preloaded GPS file. The reference coordinate frame for the obstacle map may be centered on the user's head orientation or body position.

System and Development: In order to perfect the system and methods disclosed according to the present invention, it may be preferable, a least initially, to prepare a system in which the wearable stereo camera system is interfaced with a standard PC configured with the desired user specifications. This preliminary implementation may be used to test the working of the algorithm as per specifications, and initial mobility experiments may be carried out for validation purposes.

Systems Level Integration and User Interface

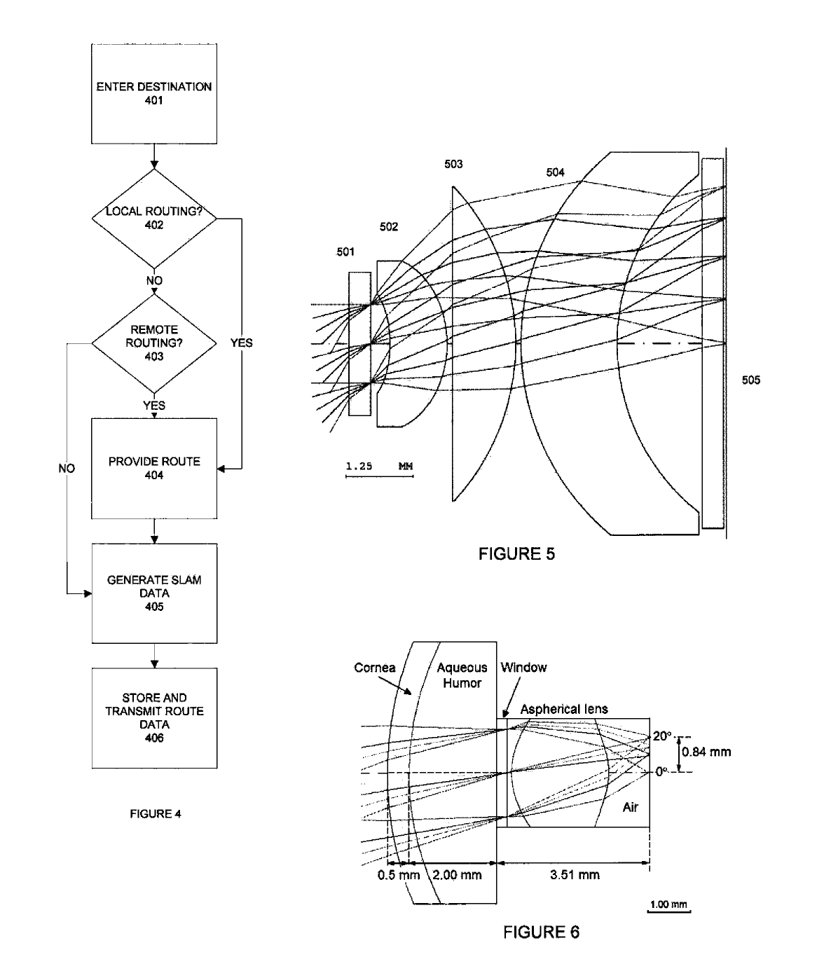

Registering SLAM trajectory with GPS online: A GPS map is typically a 2D representation. In some instances, a simulated 3D view is provided, but typically only includes roads and known buildings in a representational manner. The present system proposes the combination of a SLAM route or trajectory with GPS data coordination. An embodiment of the system is illustrated in the flow diagram of FIG. 4. At step 401, the user selects a destination from some location (e.g. the user's home or some other start point depending on the user location. At step 402 the system checks the database of the local user to determine if any SLAM data for the desired route is available. For example, if the user has taken the route before, the system stores the computed dense SLAM map along with GPS tags. If the data is available, the system uses the stored data and GPS tags as a base for routing of the user at step 404. If no local data is available, the system proceeds to decision block 403 to determine if there is route data in a database of all system users. This data is provided from each user of the system so that a database of SLAM data and coordinated GPS tags can be organically generated.

If the data is available in the remote or local database, the system retrieves it and uses it for route generation at step 404. The route data may comprise multiple stored routes that are combined in whole or part to generate the desired rout. It should be noted that the local database of the user and the remote database can be implemented in local disk storage, remote disk storage, or cloud storage as desired.

If the SLAM data is not available at either the local or remote database, the system must then generate the data on the fly at step 405. The system builds the data as the user travels the route. This will enable autonomous navigation in totally unfamiliar areas. Given a desired destination, a feedback signal from the GPS receiver will be sent when the current position reaches the target coordinates. Furthermore, if the trajectory starts deviating from the GPS waypoint, cues are provided to take corrective actions.

At step 406, the system preferably implements a map saving feature that saves the computed dense SLAM map along with GPS tags and transmits it to the local and remote database storage. Even when the route data has been provided by the local or remote database, this updating is implemented to further refine and update the routes. This enables more accurate localization during the next visit, as a pre-computed landmark map is already available. However, since local level features are subject to change over time (e.g., movable obstacles placed temporarily), this 3D map should be updated with the new information. This update may be boot-strapped by features surviving from the previous reconstruction (as it can be reasonably expected that such features will be in the significant majority), and therefore each update will improve the location and mapping accuracy.

An example of an integrated scene understanding system that is general-purpose is as follows and can be the basis for the framework developed here. Given a task definition in the form of keywords, the system first determines and stores the task-relevant entities in symbolic working memory, using prior knowledge stored in symbolic long-term memory (a large-scale ontology about objects in the world and their interrelationships). The model then biases its saliency-based visual attention for the learned low-level visual features of the most relevant entity. Next, it attends to the most salient (given the biasing) location in the scene, and attempts to recognize the attended object through hierarchical matching against stored object representations in a visual long-term memory. The task-relevance of the recognized entity is computed and used to update the symbolic working memory. In addition, a visual working memory in the form of a topographic task-relevance map is updated with the location and relevance of the recognized entity.

System Components

Data Acquisition Modules 103

In one embodiment of the system, the data acquisition module comprises an image capture system such as a camera. In one implementation, the system utilizes a highly compact, wide-field of view, wide-dynamic range camera for image capture, designed to be integrated into a wearable system with a patient cueing interface.

The field of view of the camera should match as much as possible the field of view of normally sighted individuals, and yet prove amenable to image dewarping prior to implementation of the various image processing algorithms described above. The system in one embodiment utilizes custom-designed lenses that can provide up to a 120 degree field of view or more with minimal chromatic aberration, as shown for example in FIG. 5. The lens system includes a protective window 501 followed by lenses 502, 503, and 504 which are used to focus image data onto image sensor 505. The lens system provides the ability for wide angle viewing that is nearly equal to or greater than that typically available to a human eye. In both cases, the system resolution can be higher than that of the human eye in the peripheral regions of vision, thereby allowing the system to provide enhanced environmental awareness for the user.

In addition, image sensor array 505 may be a charge coupled device (CCD) or complementary metal-oxide semiconductor (CMOS) device and may also include a wide dynamic range image sensor array. The wide dynamic range feature provides both day and night operation capability for the user.

Wide dynamic range image sensor arrays allow for the capture of a much wider brightness range between the lightest and darkest areas of a scene than more traditional image sensor arrays. The goal of these image sensors is to more accurately represent the wide range of intensity levels found in real scenes. This is useful for the proposed visual enhancement system since important objects may be in either very brightly illuminated or shaded areas. Typical image sensor arrays cannot accurately represent the actual light intensity levels, and instead assign pixel grey scale levels to a limited range of illumination values, saturating at black on one end and white on the other.

In combination, these elements of a wide angle lens and a wide dynamic range sensor array can provide a highly compact, light weight, low power video camera that can form the basis of a wearable low vision system. The camera will be mounted inconspicuously in a pair of eyeglasses, and will be wirelessly connected to the hardware platform described in the next section. Either this camera or an additional camera will be designed such that it can be used (in pairs) to provide appropriate stereo camera inputs to support the SLAM algorithm.

In another embodiment, the system may use a camera system such as in the camera in Kinnect game system, the PrimeSensor by PrimeSense, the Mesa SR-4000, the SoftKinetics DepthSense, and the like. These systems can provide depth data that can be used by the system to generate environmental information. In other embodiments, the system may utilize a 3D camera system.

User Input 104—In one embodiment, the user input 104 comprises tactile and voice inputs: An off-the-shelf voice recognition systems (IBM ViaVoice or similar) may be used that allow the users to control the system operating mode. The interface may also be a tactile interface and may be configurable based on the user. The system may comprise a list of commands that are needed to configure the system. These can involve menus and submenus and, for voice commands, could be matched to individual users. In one embodiment, the user may select commands by key or switch combinations on a tactile input device. This can be as simple as a plurality of buttons or switches where each switch represents a different command, to systems where the number of activations of one or more switches selects commands, and embodiments where different combinations of switches represent and select commands.

In one embodiment, the system may be context sensitive so that commands and modes will be active based on the context of the user. A controller algorithm preferably helps to determine user intent based on (1) environment, (2) direct user input and (3) user actions. The controller algorithm may synthesize user input and the “gist” of the scene to select and optimize the algorithms for the task. For example, if the user indicates that he is looking for a Coke™ can, the controller algorithm will prioritize the saliency-based object detection algorithm and bias the algorithm for a red object. This replaces the need to observe every object in the immediate environment to look for the one representing a soda can. On the other hand, if the gist of the video input indicates motion and an outdoor environment, the controller algorithm will prioritize the SLAM algorithm for obstacle detection while processing occasional frames for salient objects in the background, without direct user input to do so.

User Feedback 105

The user feedback system 105 is an important part of the system. Without an effective means of communicating the location of objects and obstacles to the user, even the best software algorithms will not provide a benefit to the user. The interface 105 may be a tactile and/or aural interface. The tactile interface does not necessarily attempt to provide specific information on the type of object, only indicate its location. Preliminary results indicate that a tactile interface can guide a blind-folded individual through an obstacle course. Possible user interfaces are described in some detail below. The interface may be based on the preferences of the potential users.

Tactile Interface—A set of vibration motors positioned around the torso can guide an individual down an obstacle free route. In addition, motors could guide a reach and grasp task as long as the desired object is in view of the camera. The system could detect the user's hand and provide more or less vibration as they near the object. The intensity and frequency of vibration could be modulated. Such an interface should have the following attributes: Low-power, easily positioned, and cosmetically appealing. For movement, the system can vibrate on one side or the other to indicate direction and on both sides to communicate commands such as “stop”, “continue”, and the like. In other circumstances, the rate and length of vibration signals to the user can be used to convey information. In one embodiment, the user is free to program the feedback system to the user's preferences.

Aural Interface—Rather than continuous sound, as has been used by other electronic visual aids and shown to be distracting to users, a preferable aural interface will likely be akin to GPS, providing information only as needed or when requested. For example, if the user is walking on a sidewalk, the system would be silent (except for maybe an occasional tone to indicate that it is operating), except if the user starts to veer off-course, an obstacle is approaching, or an intersection is near that requires the user to make a decision. The aural feedback could be in the form of an artificial voice, tuned to user preference. An off-the-shelf Bluetooth earpiece would provide an acceptable hardware platform.

Tactile/Aural Combination—In one embodiment, the system uses both aural and tactile feedback. Tactile feedback could be used for simple commands (“Move to the left”) while aural feedback could present more complex feedback (“You are at the corner of Main Street and First Avenue; which direction do you want to go?” or “The Coke™ can is to your left”)

In one embodiment, the tactile feedback is integrated into an article of clothing, such as a vest and/or belt, so that the user can feel the tactile actions.

Wearable Processor 101

In one embodiment, the wearable device 101 uses a combination of two Congatec XTX Intel Core 2 Duo boards (FIG. 10) powered by two MacBook batteries (˜3 hours runtime), and one or two Texas Instruments DM642, 720 MHz DSP processors (similar to the DSPs used in our preliminary work, but faster). This configuration provides essentially the same capability as two high-end Apple MacBook laptops, without LCD screens or keyboards. The embedded system will preferably include: (1) A battery power supply system (simple DC/DC converters to provide properly regulated 5V to the CPU boards); (2) A carrier board (onto which the Congatec XTX modules will plug in, and which will provide minimal input/output capabilities, including video input, USB ports, hard-drive connector, audio input); and (3) A plastic housing (CNC and FDM methods have been used previously).

The initial hardware implementation described above will be wearable in the sense that it can be configured to reside in a backpack and run for a few hours on batteries. This may suffice for lab experiments, but is unlikely to be acceptable as a medical device. The processing may be done locally or performed via cloud computing. In other embodiments, the processing is done using a smart-phone, tablet computer, or other portable computing device.

FIG. 8 illustrates one embodiment of the wearable processor of the system. Data acquisition module 801 provides data to the processing block 802. Processing block 802 performs real-time egomotion estimation by exploiting image optic flow. The camera motion estimates are used to dynamically build an occupancy map, with traversable and untraversible regions identified. From the current and previous position estimates, the direction of motion being taken by the user is computed. A SLAM map is generated (or supplemented) at block 804. Obstacle detection block 805 analyzes image input data to identify obstacles and traversability of the path of the user. Based on this direction vector and head orientation, the occupancy map is scanned for the most accessible region and a way-point is established at that coordinate. If this way-point is in close proximity to the current position, then the system switches to proximity alert mode, where all the vibration motors are turned on, indicating the user to scan around for a free path. If the way-point is at a reasonable distance away, a shortest path is computed leading to it and the system switches to guidance mode. The system uses motion prediction block 806 to track how close the user will come to identified obstacles. The system can integrate information over time to predict user intention. It can combine this information with an obstacle map, localization data, and safe-path cues to provide navigation guidance. Block 806 will send information to the control block 803 where it will be determined at block 808 if there is enough space for the user to avoid the obstacle.

If yes, the system continues with path planning block 807. (The path planning block in one embodiment is a hardware and/or firmware implementation of the SLAM algorithm. This allows the non-reactive generation of a safe path for the user). If not, the system provides an alert from proximity alert module 809. The system updates its estimate of user direction every frame, and therefore, can switch at any time from guidance mode to proximity alert mode (or vice-versa) if the user does not follow the guidance cues and steps too close to obstacles. The system provides route information to guidance module 811 which communicates with the user feedback module 812 via communications interface 810.

In one embodiment, the system uses a neuromorphic algorithm capable of highlighting important parts of a visual scene to endow it with visual attention capabilities that emulate those of normally sighted individuals. Given color video inputs, the algorithm combines a bottom-up “saliency map” that encodes the visual attractiveness of every scene location based on bottom-up (image-driven) cues in real-time, with a “task-relevance map,” which encodes the top-down (task-driven) relevance of every location given current behavioral goals. In one incarnation, the task-relevance map is derived from learned associations among the “gist” or coarse structure of a scene, and the locations that a sample group of human subjects trying to achieve a given goal looked at while presented with scenes of similar gist. This model has been shown to reliably predict the locations that attract the gaze of normal human observers while inspecting video clips of TV and natural scenes, and while engaging in specific tasks such as driving a vehicle or navigating through a novel 3D (video game) environment.

One property of this model is how it is able, with no tuning or modification, to predict human performance in visual search arrays, to detect salient traffic signs in roadside images (e.g. 512×384 pixels) filmed from a moving vehicle, pedestrians in urban settings, various salient objects in indoor scenes, or military vehicles in large (e.g. 6144×4096) aerial color images. A head mounted camera and display (HMD) is used to capture video and display a degraded image (simulating low-resolution, impaired vision) to the subject. A processor processes the video stream prior to display on the HMD, focusing on the central part of the display. This provides a coarse and narrow-field view of the world similar to what low-vision patients may experience. In parallel, the full-view images of the scene, wider than the subjects could see, were processed through a visual attention algorithm, which then issued simple direction cues towards potentially interesting locations that were outside the patient's field of view. When the visual attention algorithm is used to cue the user towards salient objects, the user located the object more quickly as compared with searching for the object without cues.

The system may also employ an accelerometer as part of the wearable system to provide additional information for the system to both identify speed and direction, and to predict the user path so that routing decisions may be made more accurately.

Intraocular (Implantable) Camera

In another embodiment, the system provides an ultraminiature camera for implantation in the eye, in order to allow for the generation of environmental image acquisition with normal foveation, allowing image acquisition to be coupled to the user's gaze direction.

In some cases, the intraocular camera may be used in conjunction with an implanted electronic retinal prosthesis. Current retinal prostheses employ a head-mounted extraocular camera for image acquisition, such that patients must move their heads to scan the environment, navigate, and find objects. This leads to an unnatural decoupling of head and eye motions that can in turn lead to disorientation and nausea, as well as diminished capability for navigation and mobility. The intraocular camera of the system may be implanted in the eye, thereby allowing for direct foveation and the natural coupling of head and eye motions.

The intraocular camera is designed for implantation in the crystalline lens sac in a manner similar to that of an intraocular lens (IOL), as shown in FIG. 6. This configuration in one embodiment is an extremely compact, lightweight package (3.0×4.5 mm, <150 mg) with a focal length of ˜2 mm (500 diopters) and an fl# close to unity. Custom intraocular camera lens systems based on polymers have been extensively studied, resulting in a lens mass of only 13 mg. The optical system length is currently only 3.5 mm, with a 2.1-mm effective focal length. At fl/0.96, the blur spot diameters are <30 um and the MTF is >0.5 at 25 line pairs per millimeter (lp/mm) over a 20° (±10°) field of view (FOV) and an extended depth of field.

In addition to meeting the requirements for a retinal prosthesis, the system design for the intraocular camera also demonstrates that extremely lightweight, low power, and compact video cameras can be envisioned for use in a compact, wide field-of-view, wide dynamic range camera as described earlier, as well as in other military and civilian applications.

Embodiment of Computer Execution Environment (Hardware)

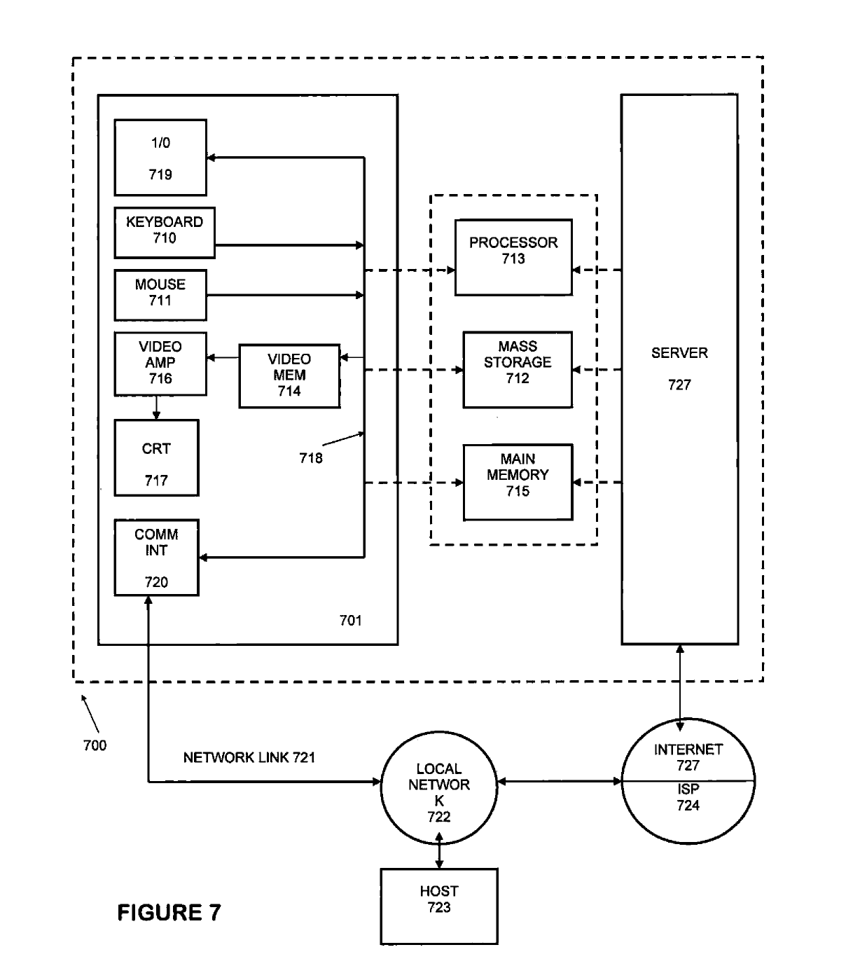

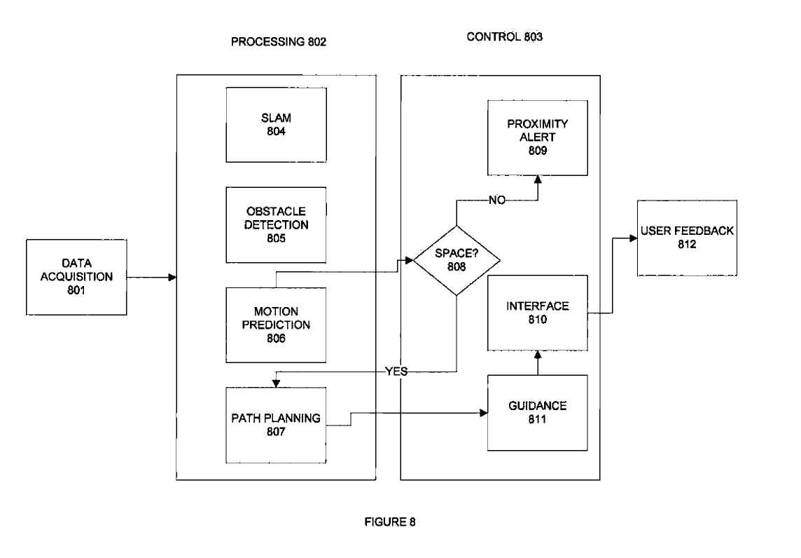

An embodiment of the system can be implemented as computer software in the form of computer readable program code executed in a general purpose computing environment such as environment 700 illustrated in FIG. 7, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 710 and mouse 711 are coupled to a system bus 718. The keyboard and mouse are for introducing user input to the computer system and communicating that user input to central processing unit (CPU 713. Other suitable input devices may be used in addition to, or in place of, the mouse 711 and keyboard 710. I/O (input/output) unit 719 coupled to bi-directional system bus 718 represents such I/O elements as a printer, A/V (audio/video) I/O, etc.

Computer 701 may be a laptop, desktop, tablet, smart-phone, or other processing device and may include a communication interface 720 coupled to bus 718. Communication interface 720 provides a two-way data communication coupling via a network link 721 to a local network 722. For example, if communication interface 720 is an integrated services digital network (ISDN) card or a modem, communication interface 720 provides a data communication connection to the corresponding type of telephone line, which comprises part of network link 721. If communication interface 720 is a local area network (LAN) card, communication interface 720 provides a data communication connection via network link 721 to a compatible LAN. Wireless links are also possible. In any such implementation, communication interface 720 sends and receives electrical, electromagnetic, or optical signals that carry digital data streams representing various types of information.

Network link 721 typically provides data communication through one or more networks to other data devices. For example, network link 721 may provide a connection through local network 722 to local server computer 723 or to data equipment operated by ISP 724. ISP 724 in turn provides data communication services through the world wide packet data communication network now commonly referred to as the “Internet” 727 Local network 722 and Internet 727 both use electrical, electromagnetic, or optical signals that carry digital data streams. The signals through the various networks and the signals on network link 721 and through communication interface 720, which carry the digital data to and from computer 700, are exemplary forms of carrier waves transporting the information.

Processor 713 may reside wholly on client computer 701 or wholly on server 727 or processor 713 may have its computational power distributed between computer 701 and server 727. Server 727 symbolically is represented in FIG. 7 as one unit, but server 727 can also be distributed between multiple “tiers”. In one embodiment, server 727 comprises a middle and back tier where application logic executes in the middle tier and persistent data is obtained in the back tier. In the case where processor 713 resides wholly on server 727, the results of the computations performed by processor 713 are transmitted to computer 701 via Internet 727, Internet Service Provider (ISP) 724, local network 722, and communication interface 720. In this way, computer 701 is able to display the results of the computation to a user in the form of output.

Computer 701 includes a video memory 714, main memory 715 and mass storage 712, all coupled to bi-directional system bus 718 along with keyboard 710, mouse 711, and processor 713.

As with processor 713, in various computing environments, main memory 715 and mass storage 712 can reside wholly on server 727 or computer 701, or they may be distributed between the two. Examples of systems where processor 713, main memory 715, and mass storage 712 are distributed between computer 701 and server 727 include thin-client computing architectures and other personal digital assistants, Internet ready cellular phones and other Internet computing devices, and platform independent computing environments

The mass storage 712 may include both fixed and removable media, such as magnetic, optical, or magnetic storage systems or any other available mass storage technology. The mass storage may be implemented as a RAID array or any other suitable storage means. Bus 718 may contain, for example, thirty-two address lines for addressing video memory 714 or main memory 715. The system bus 718 may include, for example, a 32-bit data bus for transferring data between and among the components, such as processor 713, main memory 715, video memory 714, and mass storage 712. Alternatively, multiplex data/address lines may be used instead of separate data and address lines.

In one embodiment of the invention, the processor 713 is a microprocessor such as manufactured by Intel, AMD, and Sun. However, any other suitable microprocessor or microcomputer may be utilized, including a cloud computing solution. Main memory 715 comprises dynamic random access memory (DRAM). Video memory 714 is a dual-ported video random access memory. One port of the video memory 714 is coupled to video amplifier 719. The video amplifier 719 is used to drive the cathode ray tube (CRT) raster monitor 717. Video amplifier 719 is well known in the art and may be implemented by any suitable apparatus. This circuitry converts pixel data stored in video memory 714 to a raster signal suitable for use by monitor 717. Monitor 717 is a type of monitor suitable for displaying graphic images.

Computer 701 can send messages and receive data, including program code, through the network(s), network link 721, and communication interface 720. In the Internet example, remote server computer 727 might transmit a requested code for an application program through Internet 727, ISP 724, local network 722 and communication interface 720. The received code maybe executed by processor 713 as it is received, and/or stored in mass storage 712, or other non-volatile storage for later execution. The storage may be local or cloud storage. In this manner, computer 700 may obtain application code in the form of a carrier wave. Alternatively, remote server computer 727 may execute applications using processor 713, and utilize mass storage 712, and/or video memory 715. The results of the execution at server 727 are then transmitted through Internet 727, ISP 724, local network 722 and communication interface 720. In this example, computer 701 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. In other embodiments, the system may be implemented on any suitable computing environment including personal computing devices, smart-phones, pad computers, and the like. An embodiment of the invention may be implemented in any type of computer system or programming or processing environment.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable components include but are not limited to physically mateable and/or physically interacting components and/or wirelessly interactable and/or wirelessly interacting components and/or logically interacting and/or logically interactable components.

While various aspects and embodiments have been disclosed herein, other aspects and embodiments will be apparent to those of ordinary skill in the art. The various aspects and embodiments disclosed herein are for purposes of illustration and are not intended to be limiting, with the true scope and spirit being indicated by the following claims. Those ordinarily skilled in the art will recognize, or be able to ascertain using no more than routine experimentation, many equivalents to the specific embodiments of the method and compositions described herein. Such equivalents are intended to be encompassed by the claims.

We claim:

1. A system comprising:
a data acquisition module for receiving image information associated with the environment of a user;
a user input module comprising tactile and audio controllers for receiving user commands comprising mobility and data acquisition goals;
a processor coupled to the data acquisition module and to the user input module for receiving and processing image data and for receiving and implementing user commands;
a user feedback module comprising tactile and audio feedback coupled to the processor for receiving information about the mobility and data acquisition goals.

2. The system of claim 1 wherein the data acquisition module comprises a camera.

3. The system of claim 2 wherein the camera is mounted on a pair of eyeglasses.

4. The system of claim 3 wherein the camera comprises a stereoscopic system.

5. The system of claim 1 wherein the processor is coupled to the data acquisition module, the user input module, and the user feedback module via a wireless connection.

6. The system of claim 1 wherein the user feedback module comprises a tactile feedback system.

7. The system of claim 1 wherein the user feedback module comprises an auditory feedback system.

8. The system of claim 5 wherein the processor is a cloud based processor.

9. The system of claim 1 wherein the processor comprises a processing module and a control module.

10. The system of claim 2 in which the camera further comprises a wide field of view lens.

11. The system of claim 2 in which the camera further comprises a wide dynamic range image sensor.

12. The system of claim 2 in which the camera comprises a device that provides a depth image.

13. The system of claim 2 wherein the camera is a 3D camera.

14. The system of claim 1 further including firmware implenting a path planning module for the generation of simultaneous localization and mapping (SLAM) data for use in generating a safe path for the user.

15. The system of claim 14 further including the use of neuromorphic data for use in generating a safe path for the user.

16. The system of claim 15 further including a path planning algorithm for use in generating a safe path for the user.

17. A method of providing navigation information comprising:
Receiving data from a data acquisition module;
Providing the data from the data acquisition module to a processor for generating environmental information and for identifying a safe path through the environment;
Predicting a user's direction of motion and measuring deviation from the safe path;
Transmitting feedback information from the processor to a user feedback system to indicate a user's relationship with the path.

18. The method of claim 17 wherein the data provided from the data acquisition module is depth data and wherein the processor uses the depth data to generate environmental information.

19. The method of claim 17 wherein the data is a pair of images processed to produce depth information used by the processor to generate environmental information.

20. The method of claim 17 wherein the system generates environmental information by performing simultaneous localization and mapping.

21. The method of claim 20 further including the step of obstacle detection to identify obstacles in the path.

22. The method of claim 21 further including providing a warning to the user through the feedback system.

23. The method of claim 17 wherein the user can issue commands to the processor using voice commands.

24. The method of claim 23 further including the user of tactile input to issue commands to the processor.

25. The method of claim 17 wherein the processor switches between a plurality of modes.

26. The method of claim 25 wherein the modes comprise proximity mode and mobility mode.

27. The method of claim 26 wherein the system provides object detection in response to a command from the user.

28. The method of claim 27 wherein the object detection is a neuromorphic system.

29. The method of claim 25 wherein the mode is detect and acquire mode.

30. The method of claim 29 wherein the mode allows the system to detect an object and assist the user in reaching for and grasping the object.

30. The method of claim 27 further including object recognition in response to a command from the user.

32. The method of claim 17 wherein the data acquisition module acquires images of the environment with a wide field of view.

33. The method of claim 17 wherein the data acquisition module acquires images under both low lighting conditions and high lighting conditions.

34. The system of claim 1 further including a module for object detection and recognition.
